(19) United States
(12) Patent Application Publication
(10) Pub. No.: US 2019/0211590 A1
(43) Pub. Date: Jul. 11, 2019

(54) WIRELESSLY CONTROLLED VEHICLE HOOD LATCH LOCK SYSTEM

(71) Applicant: Blue Eclipse, LLC, Westfield, IN (US)

(72) Inventor: Craig A. Tieman, Westfield, IN (US)

(73) Assignee: Blue Eclipse, LLC, Westfield, IN (US)

(21) Appl. No.: 16/329,895

(22) PCT Filed: Sep. 7, 2017
(86) PCT No.: PCT/US17/50434

§ 371 Date: Mar. 1, 2019

Related U.S. Application Data
(60) Provisional application No. 62/385,229, filed on Sep. 8, 2016.

(51) Int. Cl. E05B 83/24; E05B 79/20; E05B 81/04; E05B 81/56; E05B 81/90

(52) U.S. Cl. CPC E05B 83/243; E05B 79/20; E05B 2047/0081; E05B 81/56; E05B 81/90; E05B 81/04

(57) ABSTRACT

A wirelessly-controlled vehicle hood latch lock system which can be operated by a control device. The system includes latch control module cable installed in place of the factory hood latch release cable to control the hood release action conditional upon control signals from the control device. A latch control switch sends signals to the wireless latch control module when the factory hood latch release lever is operated. The wireless latch control module allows the transfer of movement from the factory cable to the module cable only upon receipt of an enable signal. In an alternate embodiment, a latch lock motor moves a cable jam block to lock or unlock a moveable pulley and an internal pull cable output bracket. Depending upon the position of the jam block, pulling the latch release lever will either open the hood latch or the movement of the factory cable will not be transferred to the module cable.

### BACKGROUND

The present disclosure relates to vehicle locking systems, specifically to wirelessly controlled locks of a singular design which can be added to all existing vehicle engine hood latches without special tools or training to permit external control through linkage to mobile devices. Electrical and electronic systems in automotive vehicles provide numerous functions related to the normal starting and driving operation, convenience, entertainment, access and security for vehicles. Every year, vehicle manufacturers introduce vehicles with increasing numbers of features which enhance convenience, entertainment, access and security. In addition, thieves continually attempt to learn how to circumvent vehicle security systems in an attempt to steal vehicles or vehicle components, which makes all vehicles vulnerable to theft despite the sophistication of their original electronic equipment. Furthermore, hood latching systems in vehicles have become highly standardized in their design and all have a handle inside the vehicle near the driver which pulls a cable to remotely release the mechanical latch which locks the hood closed. If a thief can gain access to the inside of a vehicle, they can easily open the engine hood to gain access to components which aid in the vehicle theft. No provision to provide additional under-hood security is provided in the event a thief gains access to the inside of a vehicle.

In recent years, the rapid and widespread growth in long-range wireless connectivity and sophisticated hand-held mobile devices with touch-type graphical user interfaces and short or long-range wireless connectivity has led to the proliferation of machine-to-machine connectivity solutions and “anywhere at any time” device interactivity. Consumers now expect all of their vehicles, homes and devices to be connected and able to be interacted with via their mobile technology from anywhere and at any time. They also expect enhanced security of their vehicles to be included with new technology.

For many years, aftermarket vehicle electronics suppliers have been offering retrofittable security and convenience systems to expand the capabilities available to vehicle owners. Security system enhancements are available to enhance the existing vehicle security features through addition of custom mechanical locking mechanisms or connections to existing vehicle electronic systems to override normal operation and create greater barriers to thieves who must overcome these systems to steal a vehicle. Other aftermarket system enhancements include the addition of remote vehicle start and keyless entry. Mechanical add-on hood lock enhancements typically require drilling or cutting on a vehicle and require special tools and training to install. Electronic security systems will integrate via wires with the original vehicle electrical system and can be defeated by a thief if they can gain access to them under the hood of the vehicle.

Presently, no wirelessly controlled lock of a singular design which can be added to most if not all existing vehicle engine hood latches without special tools or training to permit external control through linkage to mobile devices exists.

### SUMMARY

The present disclosure relates to a universal, retrofittable wirelessly-controlled vehicle hood latch lock system which can be operated by a separate remote locking and controlling system, such as a mobile device. The system includes an electro-mechanical wireless latch control module which is installed onto the vehicle's hood latch in place of the factory hood latch release cable to control the hood release action conditional upon control signals from a wireless control device, such as a smart phone. The control signal from the control device either enables or disables the transfer of movement from the factory latch release cable to a latch control module cable, which is connected to the hood latch. In this manner, the manual actuation of the hood latch can be enabled or disabled by a user.

In one embodiment of the present disclosure, a latch control switch is installed on the end of the factory latch release cable. The latch control switch detects movement of the end of the factory latch release cable and sends a control signal to the wireless latch control module when the factory hood latch release lever is operated under the vehicle dashboard. The wireless latch control module consists of an RF transceiver, a controller and power supply that combine to control a latch release motor which acts to pull the hood lock latch release cable. The wireless latch control module also has an emergency release cable which can be located in a hidden under-hood location which can be accessed from outside the hood by someone with prior knowledge of its location in the event of electrical, mechanical or battery failure. This system thus provides a secondary means of underhood access security.

The wireless latch control module is designed to be easily fitted to any existing hood latch assembly's release cable by the simple operation of installing the wireless latch control module to the latch assembly, optionally removing typically three bolts to access the latch release cable. When unlocked, pulling the factory hood latch release lever will cause the wireless latch control module to activate and pull the module hood latch release cable, opening the hood. When locked, pulling the factory hood latch release lever will do nothing.

The separate locking and controlling system can be either a mobile device with a short-range RF transceiver or a vehicle-mounted gateway telematics device which extends the range of the wirelessly controlled vehicle hood lock to reach a remotely-located mobile device. The short-range RF transceivers could use Bluetooth®, WiFi®, NFC or any other suitable RF modulation and protocol to accomplish wireless transmission of lock commands.

Accordingly, this wireless hood latch lock system could be installed by nearly anyone with simple instructions as an add-on secondary hood lock anti-theft system to their vehicle which will permit the vehicle owner to remotely lock or unlock the secondary hood lock. Remote control can be extended to the user's mobile devices over wireless links to provide short to long-range control when used in conjunction with appropriate in-vehicle telematics systems.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a schematic diagram showing the components of the wirelessly connected vehicle hood latch lock system according to one embodiment of the disclosure;

FIG. 2 is an illustration of a first embodiment of the wirelessly connected vehicle hood latch lock system of FIG. 1;

FIG. 3 is an illustration of a first embodiment of the wirelessly connected vehicle hood latch lock system of FIG. 1, with an internal view of the wireless hood latch module;

FIG. 4 is an illustration of a first embodiment of the wireless hood latch module of the wirelessly connected vehicle hood latch lock system of FIG. 1;

FIG. 5 is an illustration of a first embodiment of the wireless hood latch module of the wirelessly connected vehicle hood latch lock system of FIG. 1;

FIG. 6 is an illustration of a first embodiment of the wireless hood latch module of the wirelessly connected vehicle hood latch lock system of FIG. 1, with the latch release outer housing and latch release spring hidden;

FIG. 7 is an illustration of a first embodiment of the wireless hood latch module of the wirelessly connected vehicle hood latch lock system of FIG. 1, with the latch release tube hidden;

FIG. 8 is an illustration of a first embodiment of the wireless hood latch module of the wirelessly connected vehicle hood latch lock system of FIG. 1, with the latch release pull guide hidden;

FIG. 9 is an illustration of the module hood latch release cable connection to the hood latch and the latch control switch to the factory hood latch release cable of the wirelessly connected vehicle hood latch lock system of FIG. 1;

FIG. 10 is an illustration of the module hood latch release cable connection to the hood latch and the latch control switch to the factory hood latch release cable of the wirelessly connected vehicle hood latch lock system of FIG. 1;

FIG. 11 is an illustration of the module hood latch release cable connection to the hood latch and the latch control switch to the factory hood latch release cable of the wirelessly connected vehicle hood latch lock system of FIG. 1, with the latch control switch and wires hidden;

FIG. 12 is a schematic diagram showing the components of the wirelessly connected vehicle hood latch lock system according to a second and third embodiment of the invention;

FIG. 13 is an illustration of a second embodiment of the wirelessly connected vehicle hood latch lock system of FIG. 12;

FIG. 14 is an illustration of a second embodiment of the wirelessly connected vehicle hood latch lock system of FIG. 12, with an internal view of the wireless hood latch module;

FIG. 15 is an illustration of a second embodiment of the wireless hood latch module of the wirelessly connected vehicle hood latch lock system of FIG. 12;

FIG. 16 is an illustration of a second embodiment of the wireless hood latch module of the wirelessly connected vehicle hood latch lock system of FIG. 12, with the outer guide plates hidden;

FIG. 16a is an illustration of a second embodiment of the wireless hood latch module of the wirelessly connected vehicle hood latch lock system of FIG. 12, with the outer guide plates and electronics module hidden;

FIG. 17 is an illustration of a second embodiment of the wireless hood latch module of the wirelessly connected vehicle hood latch lock system of FIG. 12, with items hidden to show the ends of all cables;

FIG. 17a is an illustration of the module hood latch release cable connection to the hood latch of the wirelessly connected vehicle hood latch lock system of FIG. 12;

FIG. 18 is an illustration of a third embodiment of the wirelessly connected vehicle hood latch lock system of FIG. 12;

FIG. 19 is an illustration of a third embodiment of the wirelessly connected vehicle hood latch lock system of FIG. 12, with an internal view of the wireless hood latch module;

FIG. 20 is an illustration of a third embodiment of the wireless hood latch module of the wirelessly connected vehicle hood latch lock system of FIG. 12;

FIG. 21 is an illustration of a third embodiment of the wireless hood latch module of the wirelessly connected vehicle hood latch lock system of Fog. 12, with the outer guide plates hidden; and

FIG. 22 is an illustration of a third embodiment of the wireless hood latch module of the wirelessly connected vehicle hood latch lock system of FIG. 12, with items hidden to show the ends of all cables.

### DETAILED DESCRIPTION

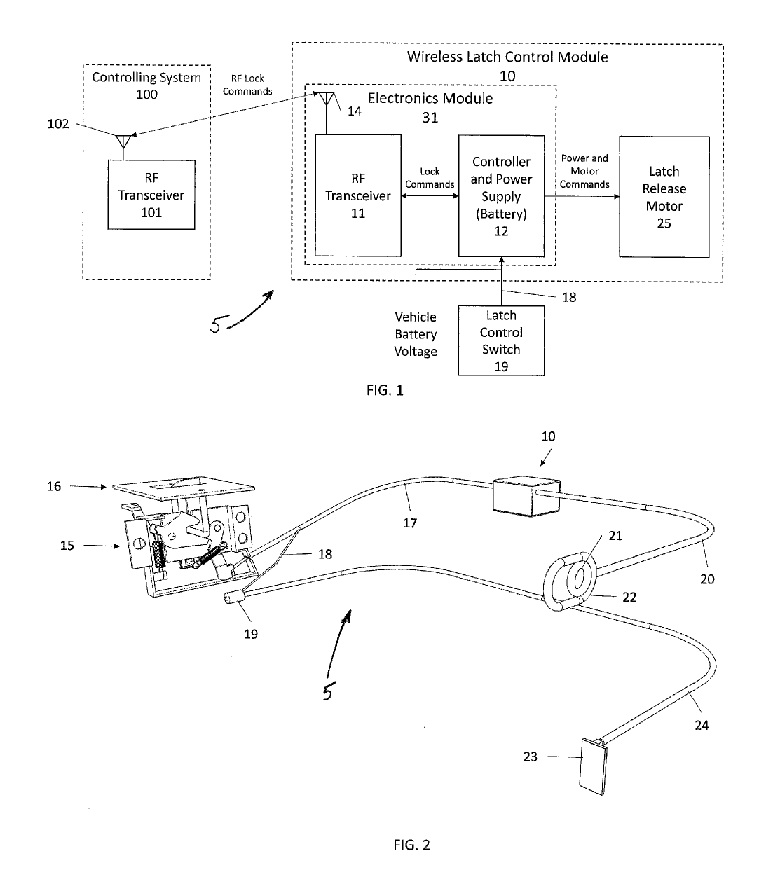

FIG. 1 is a schematic diagram of the wirelessly controlled vehicle hood latch lock system 5 according to a first embodiment of the present disclosure. Wireless control devices 100 contains an RF transceiver 101 with an RF antenna 102 which communicates control commands, such as lock and unlock commands, wirelessly with a wireless latch control module 10 and specifically with a latch control module RF transceiver 11 via latch control module RF antenna 14. Latch control module RF transceiver 11 sends demodulated enable and disable commands to an internal controller of the combined controller and power supply 12. The controller and power supply 12 powers the latch release motor 25 of the first embodiment. Latch control switch 19 is mechanically connected to the factory hood latch release cable 24 (FIG. 2) and is connected via latch control switch wires 18 to the controller contained within electronics module 31.

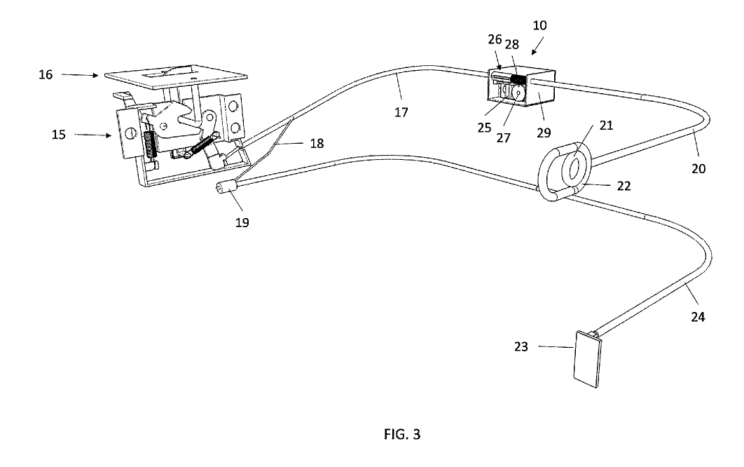

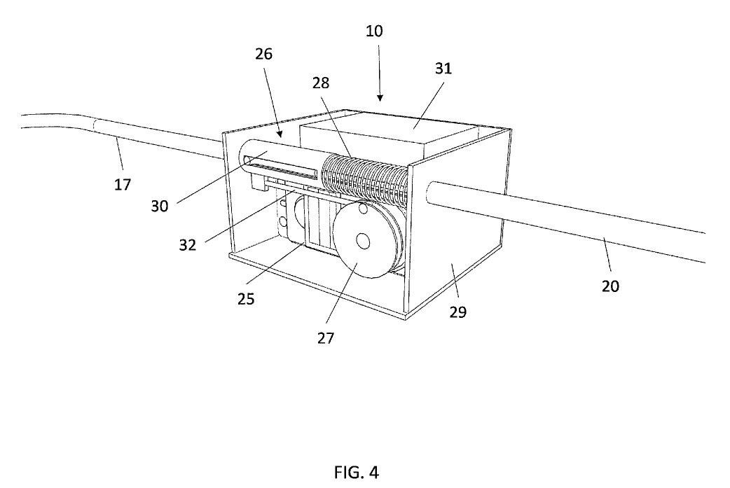

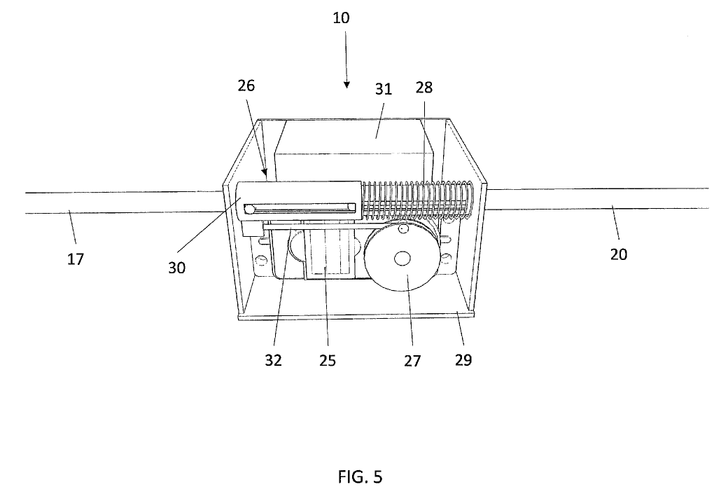

FIG. 2 shows the wirelessly controlled vehicle hood latch lock system 5 connected to a hood latch 15 and factory hood latch release cable 24. FIG. 3 shows the system of FIG. 2, except with the cover of the wireless latch control module 10 removed to reveal the interior components. FIG. 4 and FIG. 5 show a close-up view of the wireless latch control module 10.

Electronics module 31 is connected to latch release motor 25 which turns latch release motor pulley 27. When the pulley 27 rotates, the latch release motor cable 32 is shortened. The latch release motor cable 32 is attached to latch release outer pull housing 30 which slides and compresses latch release spring 28. Module hood latch release cable 17 and emergency release cable 20 are connected to opposite ends of latch release assembly 26.

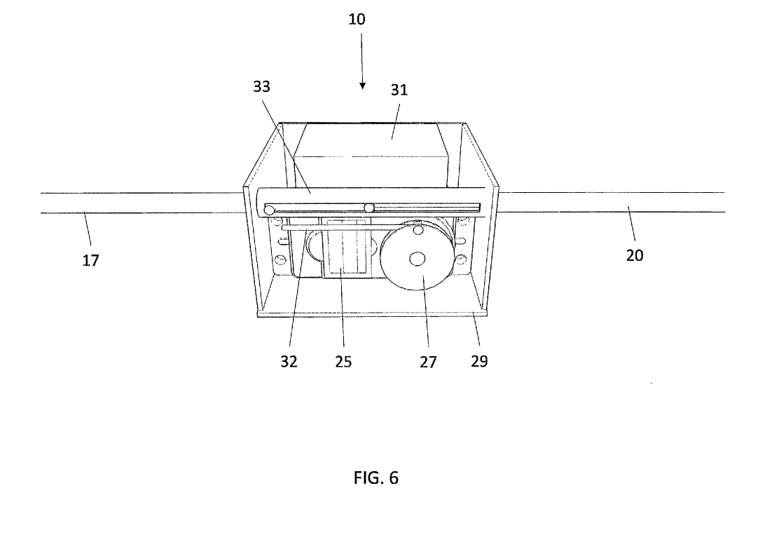

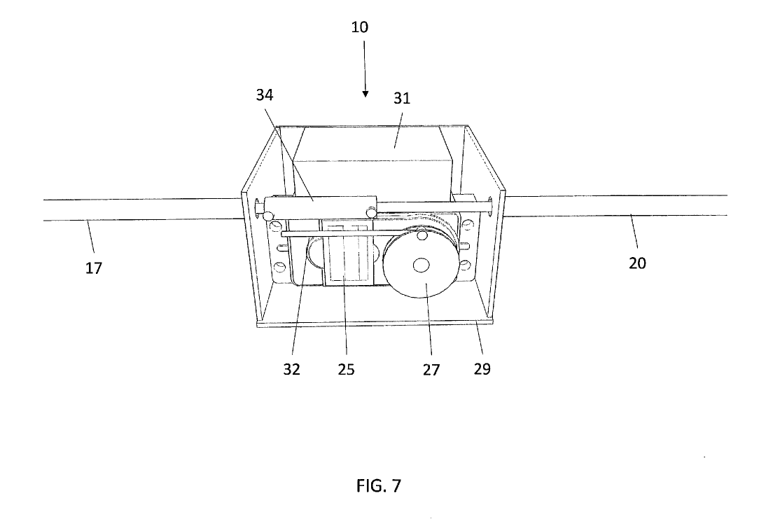

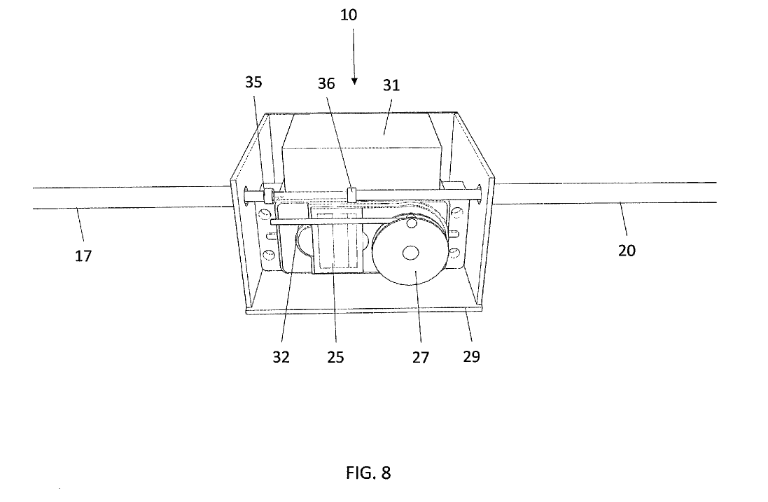

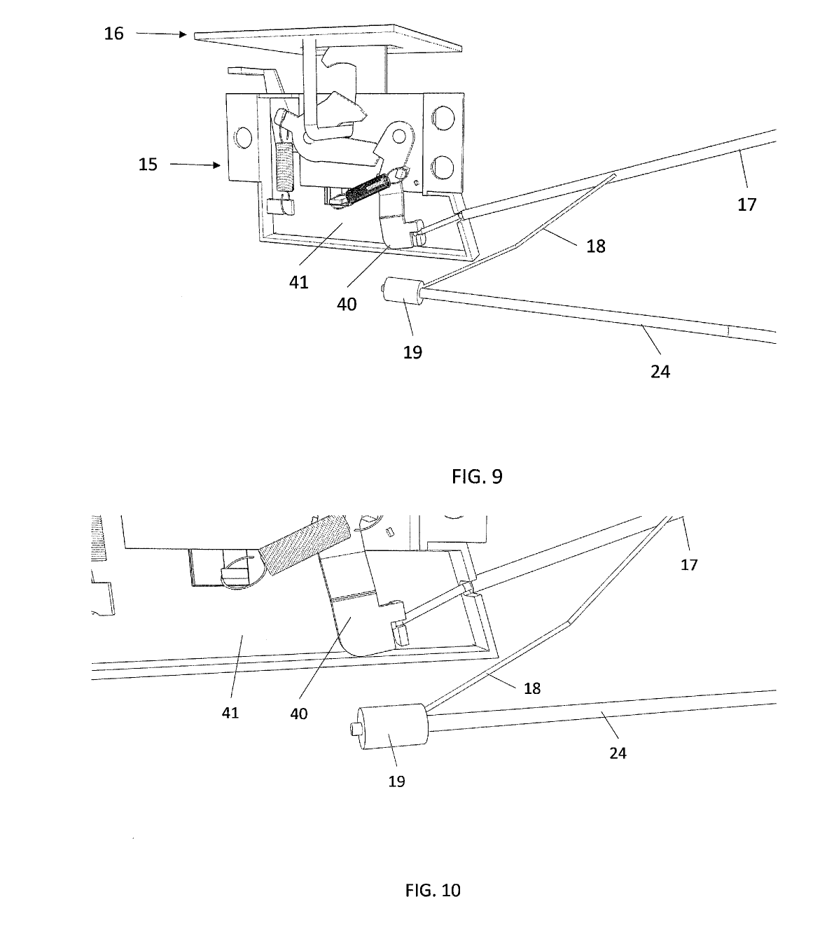

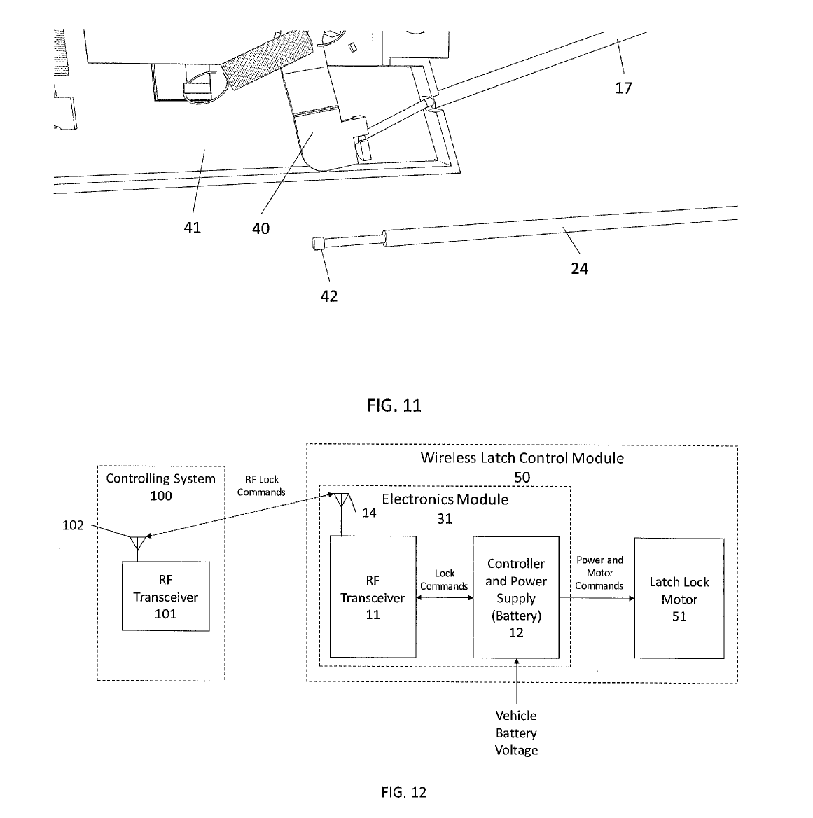

FIG. 6 shows wireless latch control module 10 with latch release outer pull housing 30 and latch release spring 28 removed. Latch release tube 33 is attached at both ends to opposite sides of enclosure 29. FIG. 7 shows wireless latch control module 10 with latch release tube 33 removed to show latch release pull guide 34 which provides the attachment for the ends of the module hood latch release cable 17 and emergency release cable 20. FIG. 8 shows wireless latch control module 10 with latch release pull guide 34 removed and module hood latch release cable end 35 and emergency release cable end 36 exposed. FIG. 9 and FIG. 10 show hood latch 15 and hood striker 16 with the factory hood latch release cable 24 removed and the module hood latch release cable 17 attached to hood latch release lever 40 and hood latch housing 41. Latch control switch 19 is affixed to the end of factory hood latch release cable 24 and the switch contacts are brought through latch control switch wires 18 to the electronics module 31. FIG. 11 shows the factory hood latch release cable 24 with the latch control switch 19 and latch control switch wires 18 removed.

FIG. 12 is a schematic diagram of the wirelessly controlled vehicle hood latch lock system according to a second and third embodiment. Controlling system 100 contains an RF transceiver 101 with an RF antenna 102 which communicates lock and unlock commands wirelessly with a wireless latch control module 50 and latch control module RF transceiver 11 via latch control module RF antenna 14. Latch control module RF transceiver 11 sends the demodulated lock and unlock commands to the controller and power supply 12. The controller and power supply 12 powers the latch lock motor 51.

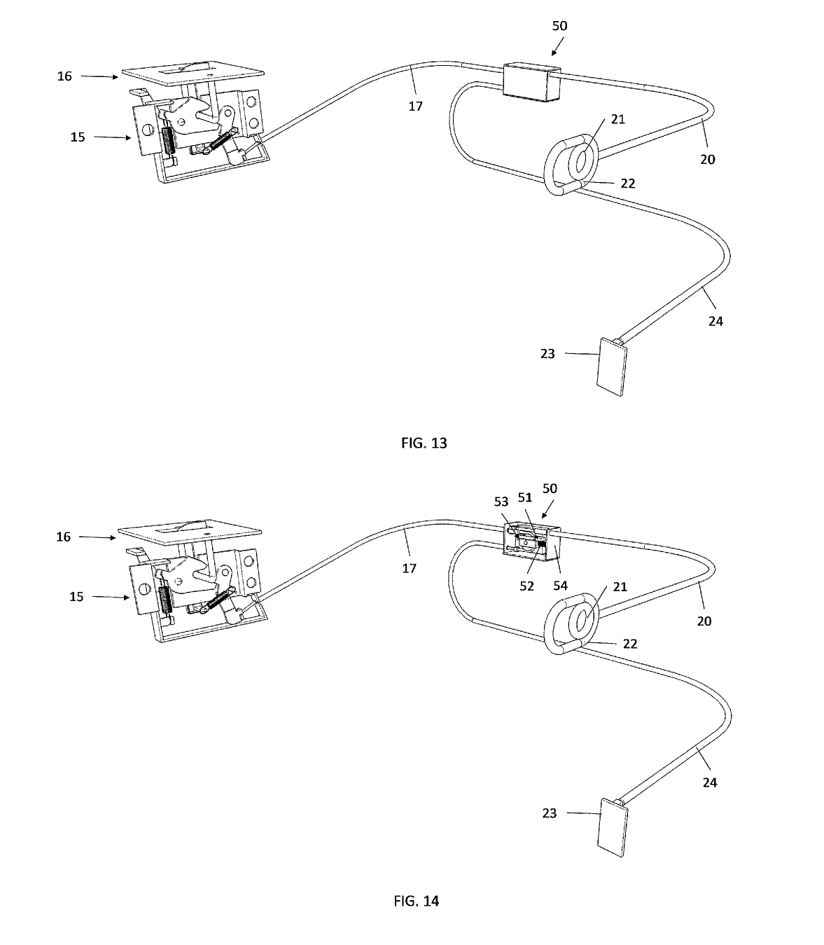

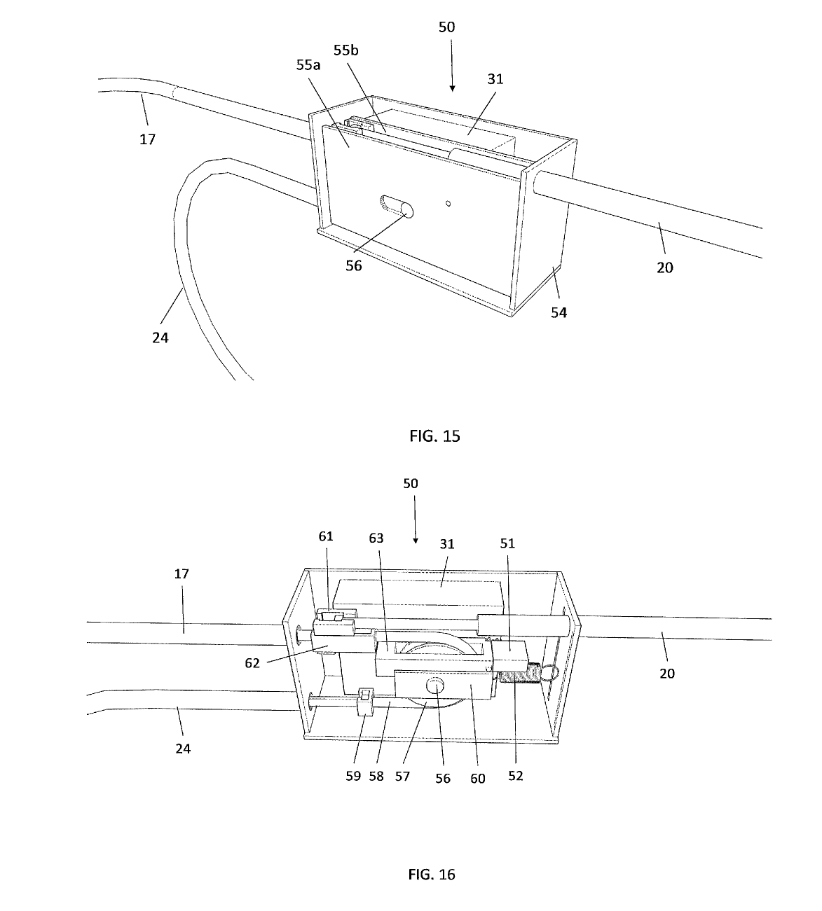

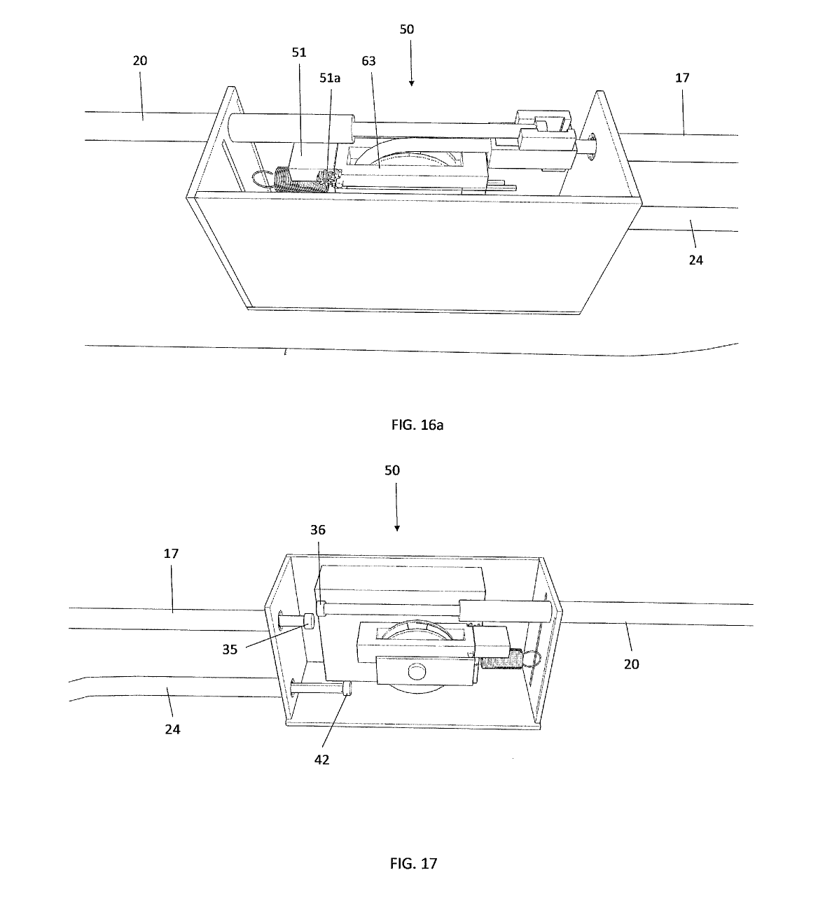

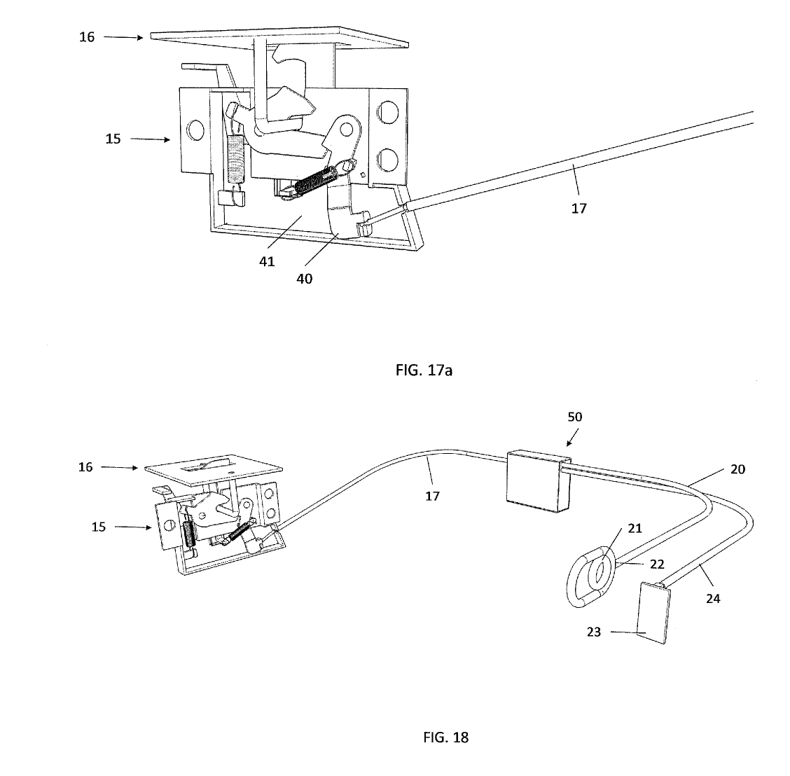

FIG. 13 shows the wirelessly controlled vehicle hood latch lock system connected to a hood latch 15 and factory hood latch release cable 24 according to a second embodiment. FIG. 14 shows the system of FIG. 12, except with the wireless latch control module 50 cover removed to reveal the interior components. FIG. 15, FIG. 16, FIG. 16a and FIG. 17 show a close-up view of the wireless latch control module 50. Factory hood latch release cable 24 has factory cable end 42 connect to internal pull cable input bracket 59 which pulls internal pull cable 58 around moveable pulley 57 which is held by moveable pulley bracket 60 and rotates on pulley shaft 56 and pulls on internal pull cable output bracket 62 which connects to output cable end 35 of module hood latch release cable 17. Pulley return spring 52 is connected to moveable pulley bracket 60 and provides tension on factory hood latch release cable 24 and returns moveable pulley 57 to normal position. Emergency release cable 20 has an emergency cable end 36 which connects to emergency release bracket 61 which slides inside of internal pull cable output bracket 62 to also pull the module hood latch release cable 17. FIG. 17a shows the module hood latch release cable 17 connected to hood latch release lever 40. Electronics module 31 is controls latch lock motor 51 which turns motor gear 51a which in turn rotates cable jam block 63.

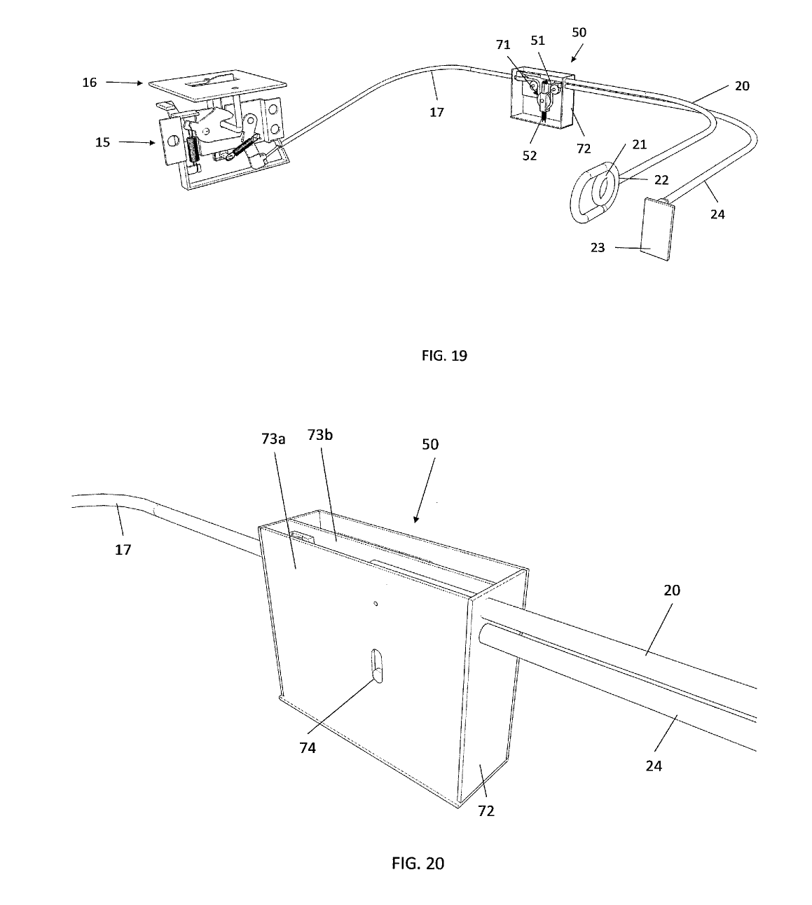

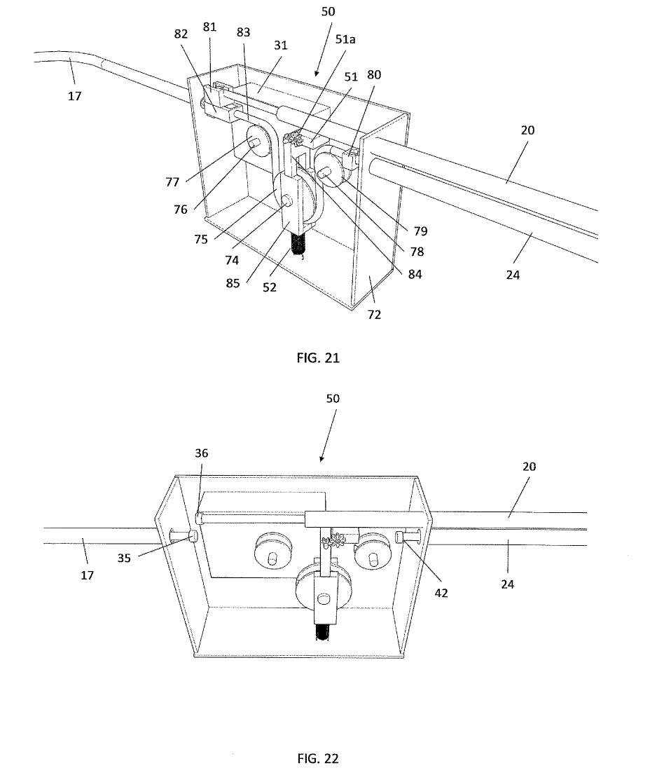

FIG. 18 shows the wirelessly controlled vehicle hood latch lock system connected to a hood latch 15 and factory hood latch release cable 24 according to a third embodiment. FIG. 19 shows the system of FIG. 12, except with the wireless latch control module 50 cover removed to reveal the interior components. FIG. 20, FIG. 21 and FIG. 22 show a close-up view of the wireless latch control module 50. Factory hood latch release cable 24 has factory cable end 42 connect to internal pull cable input bracket 80 which pulls internal pull cable 83 around first fixed pulley 79 which rotates around first pulley shaft 78 and then around moveable pulley 75 which is held by moveable pulley bracket 85 and which rotates on moveable pulley shaft 74 and then around second fixed pulley 77 which rotates around second pulley shaft 76 and pulls on internal pull cable output bracket 82 which connects to output cable end 35 of module hood latch release cable 17. Pulley return spring 52 is connected to moveable pulley bracket 85 and provides tension on factory hood latch release cable 24 and returns moveable pulley 75 to normal position. Emergency release cable 20 has an emergency cable end 36 which connects to emergency release bracket 81 which slides inside of internal pull cable output bracket 82 to also pull the module hood latch release cable 17. FIG. 17a shows the module hood latch release cable 17 connected to hood latch release lever 40. Electronics module 31 is controls latch lock motor 51 which turns motor gear 51a which in turn rotates cable jam block 84.

In one embodiment the controlling system 100 may be a wireless mobile device with an RF transceiver 101 which sends user commands via wireless RF directly to the RF transceiver 11 within the wireless latch control module 10. In another embodiment the controlling system 100 may be a gateway device with an RF transceiver 101 located within the vehicle which communicates wirelessly to the RF transceiver 11 within the wireless latch control module 10.

In other embodiments, the wirelessly-controlled vehicle hood lock could be powered by vehicle battery instead of an internal battery. The addition of position sensors or switches could enable detection of hood position which could be communicated wirelessly to the controlling system.

Operation

In operation, the wirelessly controlled vehicle hood latch lock system is connected to a hood latch 15 and factory hood latch release cable 24 and secured within the vehicle engine compartment. In the first embodiment, latch control switch 19 would be opened and closed by operation of the factory hood latch release lever 23 which pulls the factory hood latch release cable 24. Although one type and location of the latch control switch is shown, various other locations and types of devices are contemplated as long as the latch control switch can detect the operation of the latch release lever 23. The latch control switch could also be coupled directly to the latch release lever 23 to detect actuation by the user.

Pulling on factory hood latch release lever 23 will cause latch control switch 19 to close and generate a signal that is communicated to the electronics module 31 through the latch control switch wires 18. As discussed previously, the control device of the controlling system 100 will be used to send unlock or lock commands to the wireless latch control module 10. In one contemplated embodiment, the control device of the controlling system could be a smart phone, tablet, laptop or any other device capable of generating control signals.

Controlling system 100 will send a unlock/enable command via controlling system RF transceiver 101 and controlling system RF antenna 102 to latch control module RF antenna 14 and latch control module RF transceiver 11 which will send the command to the controller of the controller and power supply 12. When unlocked/enabled, a subsequent latch control switch 19 closure will cause the controller and power supply 12 to power up the latch release motor 25 and cause it to turn the latch release motor pulley 27 and pull the latch release motor cable 32. This movement will pull the latch release outer pull housing 30, causing it to slide over the latch release tube 33 against the latch release spring 28. When the latch release outer pull housing 30 moves, it also engages with the two protruding pins of latch release pull guide 34 closest to the module hood latch release cable 17, causing it to move and pull on module hood latch release cable end 35 and pulling on hood latch release lever 40, opening the hood.

When the control device sends a lock/disable control command, pulling on the factory hood latch release lever will not result in any operation of the latch release motor 25. Thus, the release of the hood latch will be disabled even when the user pulls on the factory hood latch release lever 23.

In the embodiment shown, the system includes the emergency pull handle 21. If a user pulls on the emergency pull handle 21, the movement will pull on the emergency release cable 20 which will pull the emergency release cable end 35 and pull the latch release pull guide 34. This will cause the latch release pull guide 34 to pull the module hood latch release cable end 35, resulting in pulling the hood latch release lever 40 and opening the hood. Thus, an emergency system exists for situation when power may be lost, a control device is not available or if the system is malfunctioning.

In the second embodiment, pulling the factory hood latch release lever 23 will pull the factory hood latch release cable 24 which will pull on the internal pull cable 58. If the jam block 63 is in the enabled (locked) position shown, the moveable pulley 57 will not be allowed to move and internal pull cable 58 movement will be transferred to the module hood latch release cable 17 to unlock the hood latch 15.

If the latch lock motor 51 rotates cable jam block 63 to the disabled (unlocked) position, moveable pulley 57 and pulley shaft 56 are free to slide within the slots of the outer guide plates 55a and 55b while the cable jam block 63 prevents movement of internal pull cable output bracket 62. Pulling on factory hood latch release cable 24 will only move moveable pulley 57 but not module hood latch release cable 17.

In the embodiment shown, the system includes the emergency pull handle 21. If a user pulls on the emergency pull handle 21, the emergency pull handle 21 will pull on the emergency release cable 20 which will pull the emergency release cable end 35 and pull the emergency release bracket 61. This will cause the emergency release bracket 61 to pull the module hood latch release cable end 35, resulting in pulling the hood latch release lever 40 and opening the hood.

In the third embodiment, pulling the factory hood latch release lever 23 will pull the factory hood latch release cable 24 which will pull on the internal pull cable 83. If the jam block 84 is in the enabled (locked) position shown, the moveable pulley 75 will not be allowed to move and internal pull cable 83 movement will be transferred to the module hood latch release cable 17 to unlock the hood latch 15. If the latch lock motor 51 rotates cable jam block 84 to the disabled (unlocked) position, moveable pulley 75 and pulley shaft 74 are free to slide within the slots of the outer guide plates 73a and 73b while the cable jam block 84 prevents movement of internal pull cable output bracket 82. Pulling on factory hood latch release cable 24 will only move moveable pulley 75 but not module hood latch release cable 17. Pulling on emergency pull handle 21 will pull on the emergency release cable 20 which will pull the emergency release cable end 35 and pull the emergency release bracket 81. This will cause the emergency release bracket 81 to pull the module hood latch release cable end 35, resulting in pulling the hood latch release lever 40 and opening the hood.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system for controlling the ability to release a hood of a vehicle having a hood latch and a factory hood latch release cable, the system comprising:
a control device having a transceiver for transmitting control commands;
a wireless latch module including a control module transceiver that communicates with the transceiver of the control device to receive control commands;
a module hood latch release cable extending from the wireless lock module to the hood latch; and
an actuator contained within the latch module and operable based upon the received control commands to adjust the length of the module hood latch release cable to move the hood latch between latched and unlatched conditions.

2. The system of claim 1 wherein the actuator is a drive motor contained within the wireless latch module.

3. The system of claim 1 further comprising a latch control switch positioned to detect the movement of the factory hood latch release cable, wherein the latch control switch is in communication with the wireless latch module.

4. The system of claim 3 wherein the actuator operated to adjust the length of the module hood latch release cable based upon both the control commands and the detected movement of the factory hood latch release cable.

5. The system of claim 1 further comprising an emergency release cable extending into the wireless latch module and coupled to the module hood latch release cable.

6. The system of claim 3 wherein the wireless latch module includes a controller positioned to receive the control commands from the control module transceiver and an indicator signal from the latch control switch, wherein the controller operates the actuator only when the controller receives an enable command from the control device and the indicator signal from the latch control switch.

7. The system of claim 3 wherein the latch control switch detects movement of an outer end of the factory hood latch release cable.

8. The system of claim 1 wherein the control device is a smartphone.

9. The system of claim 1 wherein the wireless latch module is mounted within an engine compartment of the vehicle.

10. A system for utilizing a control device having a transceiver to control the ability to release a hood of a vehicle having a hood latch and a factory hood latch release cable, the system comprising:
a wireless latch module including a control module transceiver that communicates with the transceiver of the control device to receive control commands from the control device;
a module hood latch release cable extending from the wireless lock module to the hood latch; and
a movement connector positioned within the latch module and operable based upon the received control commands to selectively transfer movement of the factory hood latch release cable to the module hood latch release cable to move the hood latch between latched and unlatched conditions.

11. The system of claim 10 wherein the wireless latch module includes a controller positioned to receive the control commands from the control module transceiver, wherein the controller operates to allow the transfers movement from the factory hood latch release cable to the module hood latch release cable only when the controller receives an enable command from the control device.

12. The system of claim 11 wherein the movement connector includes a pulley mounted to a movable pulley block and a pulley jamb block.

13. The system of claim 12 further comprising a drive motor operable by the controller to move the pulley jamb block between an enabled position and a disabled position.

14. The system of claim 10 wherein the control device is a smartphone.

15. The system of claim 10 further comprising an emergency release cable extending into the wireless latch module and couple to the module hood latch release cable.

16. A method of utilizing a control device to selectively enable and disable a hood latch of a vehicle having a factory hood latch release cable, the system comprising:
positioning a wireless latch module within the vehicle, the wireless latch module including a transceiver and a controller;
receiving enable and disable signal at the controller from the control device;
allowing the transfer of movement from the factory hood latch release cable to a module hood latch release cable only upon receiving the enable signal.

17. The method of claim 16 further comprising the step of detecting movement of the factory hood latch release cable and operating an actuator to adjust the length of the module hood latch release cable upon receipt of the enable signal.

18. The method of claim 16 further comprising the step of preventing the transfer of movement from the factory hood latch release cable to the module hood latch release cable upon receiving the disable signal.
